(19) United States
(12) Patent Application Publication
(10) Pub. No.: US 2002/0082854 A1
(43) Pub. Date: Jun. 27, 2002

(54) Profits sharing system for agency service, method thereof, and computer readable recording medium

(75) Inventors: Takashi Furuta, Kawasaki (JP); Masahiro Kataoka, Kawasaki (JP); Shinji Onzuka, Kawasaki (JP); Akio Okuhata, Kawasaki (JP)

Correspondence Address: STAAS & HALSEY LLP, 700 11TH STREET, NW, SUITE 500, WASHINGTON, DC, 20001, US

(73) Assignee: Fujitsu Limited, Kawasaki (JP)

(21) Appl. No.: 09/901,114

(22) Filed: Jul. 10, 2001

(30) Foreign Application Priority Data
Dec. 27, 2000 (JP) 2000-398965

(51) Int. Cl. G06F 17/60

(52) U.S. Cl. 705/1; 705/30

(57) ABSTRACT

A system for sharing profits gain from an agency service, includes a storage module for storing amounts of share target money, which should be shared to a plurality of providers, of profits obtained by operating for a predetermined period an agency service for providing users with a plurality of services provided from a plurality of providers, and a calculation module for calculating an amount of shared money allocated to each service from within the amount of share target money stored in the storage module on the basis of a frequency of providing each service during the predetermined period.

### BACKGROUND OF THE INVENTION

1. Field of the Invention

The present invention relates generally to a profit sharing system for an agency service for providing users with a plurality of services provided from a plurality of providers, a profit sharing method, and a computer readable recording medium. The present invention relates more particularly to a profit sharing system for an agency service, charged a fee, for brokering in, e.g., a content providing service for providing contents of information such as dictionaries, books, news etc and economic information as well on Web, a profit sharing method and a computer readable recording medium.

2. Description of the Related Art

A content providing service for retaining a plurality of on Web and providing the content in response to a request given from a user (client), has been performed over the recent years.

One category of the content providing services may be a Web search service in which the user accesses dictionary contents prepared on Web through a client terminal device, and searches and browses desired items of information by making use of the dictionary content provided.

The Web search service has hitherto been provided base on a system individual to a dictionary content provider. For instance, a Web site for providing the dictionary content is configured for every dictionary content provider.

Therefore, an information browsing user (the user of the dictionary content) selects beforehand any one of information sources (the dictionary contents) and narrows these sources down to one single dictionary content for use. Alternatively, contracts for providing the dictionary contents are agreed upon between a plurality of dictionary content providers and the user, and the user selects a proper dictionary content when using the dictionary content.

As explained above, the dictionary content has hitherto been provided individually by the provider, and, if the user established the contracts with the plurality of providers for using the dictionary contents, must select a proper dictionary content and access the Web site where the selected dictionary content is prepared. Accordingly, the user has to access (jump to) other Web site in the case of using other dictionary content. In addition, each of the dictionary contents is provided on a platform (a base environment for operation) individual to the provider. Hence, this interface is less user-friendly because of the user's having a different feeling about the operation for every dictionary content. For the reasons given above, the user might be unable to access the desired item of information quickly.

Under such circumstances, if the contents provided by the plurality of providers are provided on one single Web site, it is feasible to increase opportunities for the user to browse the respective contents. This leads to a presumption that the number of users of the contents can be increased. Moreover, if the plurality of contents are provided on the same platform, it can be considered that amore enhanced user-friendly interface can be attained and the number of users can also be increased. Accordingly, if the plurality of dictionary contents are provided on one single Web site and the common platform (the user interface) is provided, it can be considered that the number of users is increased.

By the way, in the case of providing the plurality of contents on the single Web site, a preferable arrangement in terms of attaining the more enhanced user-friendly interface and increasing the number of prospective contractors (users) is not that the user establishes the contract individually with each content provider but that the user establishes a package contract for providing the plurality of contents.

If the package contract is agreed upon, the profits gained based on the contract must be shared to a plurality of providers. It is herein considered that the profits are shared, for example, evenly to the plurality of providers. If usage frequencies of the contents are different from each other, however, there might be a possibility in which some providers complain of the shares.

### SUMMARY OF THE INVENTION

It is a primary object of the present invention to provide a profit sharing system for an agency service that is capable of sharing, to providers without any complaint, profits gained from an agency service for providing users with a plurality of services provided from a plurality of providers, a profit sharing method and a computer readable recording medium.

To accomplish the above object, according to one aspect of the present invention, a profit sharing system for an agency service comprises a storage module storing amounts of share target money, which should be shared to a plurality of providers, of profits obtained by operating for a predetermined period an agency service for providing users with a plurality of services provided from a plurality of providers, and a calculation module calculating an amount of shared money allocated to each service from within the amount of share target money stored in the storage module on the basis of a frequency of providing each service during the predetermined period.

According to the present invention, an amount of shared money corresponding to a providing frequency is calculated for every service. Accordingly, the calculated amount of shared money is shared to the service provider, and the service provider receives the shared money without any complaint.

The “service” may include both of a service for providing the user with a commercial article and a service for providing a duty (function and work). The “agency service” may include a service (a brokerage service in a narrow sense) for introducing the user to the service provider (for intermediating between the user and the service provider so as to get contact with each other), and a service (a proxy service for providing the service) for providing a service desired by the user as a proxy in place of the service provider. The service of the former category is a service for, for instance, connecting the user (client) to a system for the service provider to providing the service to the user. The service of the latter category is a service for providing the user with, for example, a content corresponding to a user's request among a plurality of contents provided from a plurality of providers.

The present invention can be embodied by way of a profit sharing method capable of exhibiting the same features as those of the profit sharing system described above, and a recording medium recorded with a program for a computer to execute a profit sharing process, by which the object of the present invention can also be accomplished.

According to another aspect of the present invention, a profit sharing system for an agency service comprises a providing module providing an agency service for providing a user with a requested service among services provided by a plurality of providers, and a calculation module calculating an amount of shared money, shared to each provider, of profits obtained by providing the agency service on the basis of a frequency of providing the user with the service.

The profit sharing system can be embodied by way of a profit sharing system for a content providing service, comprising a providing module providing the user with, for example, a requested content among contents provided by the plurality of providers, and a calculation module calculating the amount of shared money, shared to each provider, of profits obtained by providing the user with the content on the basis of the frequency of providing the user with the content.

According to a further aspect of the present invention, a profit sharing method in an information processing system, for an agency service, including a storage module and a control unit, comprises a step of making the control unit provide the agency service for providing a user with a requested service among services provided from a plurality of providers, a step of storing the storage module with a providing count of providing the service to the user, and a step of calculating an amount of shared money, shared to each provider, of profits obtained by the agency service on the basis of a providing frequency of each service that is obtained from the providing count of each service and a total sum of service providing counts.

The profit sharing method in the information processing system, for the agency service, including the storage module and the control unit, can be embodied by way of a profit sharing method comprising a step of making the control unit provide the user with a requested content among contents provided from the plurality of providers, a step of storing the storage module with a providing count of providing the content to the user, and a step of calculating an amount of shared money, shared to each provider, of profits obtained by providing the users with the contents on the basis of a providing frequency of each content that is obtained from the providing count of each content and a total sum of content providing counts.

According to a still further aspect of the present invention, there is provided a computer readable recording medium recorded with a program, executed by a computer and is provided a program comprising a step of providing the agency service for providing a user with a requested service among services provided from a plurality of providers, a step of storing the storage module with a providing count of providing the service to the user, and a step of calculating an amount of shared money, shared to each provider, of profits obtained by the agency service on the bas is of a providing frequency of each service that is obtained from the providing count of each service and a total sum of service providing counts.

The computer readable recording medium recorded with the program executed by the computer and the program can be embodied by way of a computer readable recording medium recorded with a program executed by a computer and a program, each program comprising a step of providing the user with a requested content among contents provided from the plurality of providers, a step of storing the storage module with a providing count of providing the content to the user, and a step of calculating an amount of shared money, shared to each provider, of profits obtained by providing the users with the contents on the basis of a providing frequency of each content that is obtained from the providing count of each content and a total sum of content providing counts.

### BRIEF DESCRIPTION OF THE DRAWINGS

FIG. 1 is an explanatory diagram showing a content providing service;

FIG. 2 is a diagram showing an example of an architecture of a content providing system;

FIG. 3 is a diagram showing a display example of a content providing screen;

FIG. 4 is an explanatory diagram showing a sharing process;

FIG. 5 is an explanatory diagram showing the content providing service in a second embodiment;

FIG. 6 is a diagram showing an example of an architecture of a content providing system (search system);

FIG. 7 is an explanatory diagram showing an operational example for setting a search option;

FIG. 8 is a diagram showing a display example of a search option setting page;

FIG. 9 is an explanatory diagram showing an operational example of a request for a list of searched results;

FIG. 10 is a diagram showing a display example of a search page;

FIG. 11 is an explanatory diagram showing an operational example of a request for details of the searched results;

FIG. 12 is a diagram showing an example of a data structure in a storage module shown in FIG. 6;

FIG. 13 is a flowchart showing a main routine of the sharing process;

FIG. 14 is a flowchart showing a beginning-of-month process shown in FIG. 12;

FIG. 15 is a flowchart showing a normal process shown in FIG. 12; and

FIG. 16 is a flowchart showing an end-of-month process (close-of-month process) shown in FIG. 12.

### DETAILED DESCRIPTION OF THE PREFERRED EMBODIMENTS

Embodiments of the present invention will hereinafter be described with reference to the accompanying drawings. The following embodiments are given by way of exemplification of the present invention, and the present invention is not limited to configurations in the embodiments.

[First Embodiment]

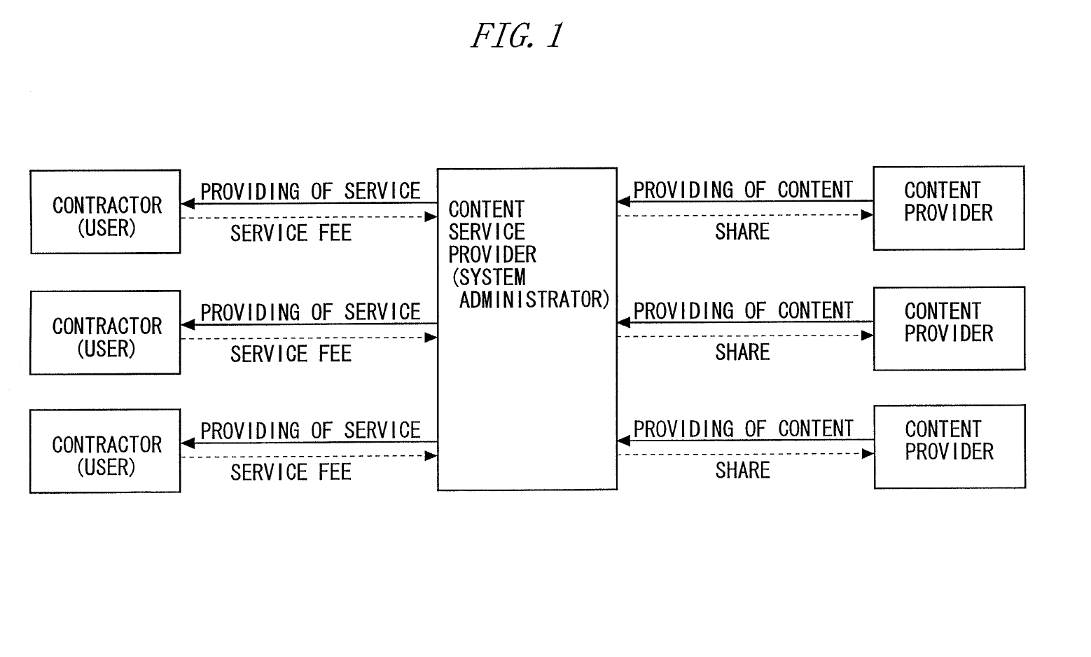

FIG. 1 is an explanatory diagram showing services for providing contents according to the present invention. Referring to FIG. 1, a provider (that may be categorized as an agent, i.e., the provider of agency services) of the content providing services (which correspond to [agency services] according to the present invention), retains a plurality of contents provided from a plurality of content providers (that correspond to providers of [services] according to the present invention).

The provider of the content providing services (that will hereinafter be called a [service provider] or an [agent]) establishes a package contract for providing a plurality of contents with one or more users. The service provider selects a content corresponding to a request among the plurality of contents and provides the selected content to the user. Namely, the agent as a substitute for the content provider provides a desired content to the user.

Each user (a contractor) pays an agent a service fee (a usage fee for the agency service) based on the contract for every predetermined period (for instance, monthly). For example, each user pays the service fee into a bank account of the agent.

The agent calculates per predetermined period a share target amount of money as an amount of money that should be shared to each content provider from a total sum of service fees (profits) within that predetermined period. The share target amount of money is, for example, an amount of money obtained by subtracting an operating cost (the operating cost for the agency service) for the content providing service from the total sum of service fees. The operating cost includes a maintenance expenditure of a system for providing the content providing services (the agency services for providing the contents), and a brokerage fee for the agent to broker between the content provider and the user.

Subsequently, the agent respectively calculates a share target amount of money as an amount of shared money that should be shared to the content provider per content in accordance with a frequency at which to provide the user with each content (which maybe conceived as a frequency at which the user uses each content.

Thereafter, the agent pays the content provider for each content the shared money corresponding to each content. For instance, the agent asks a financial institution to pay the share target money from an agent' own bank account and transfer the shared money to the provider of each content. Each provider receives the shared money as a share for providing the content.

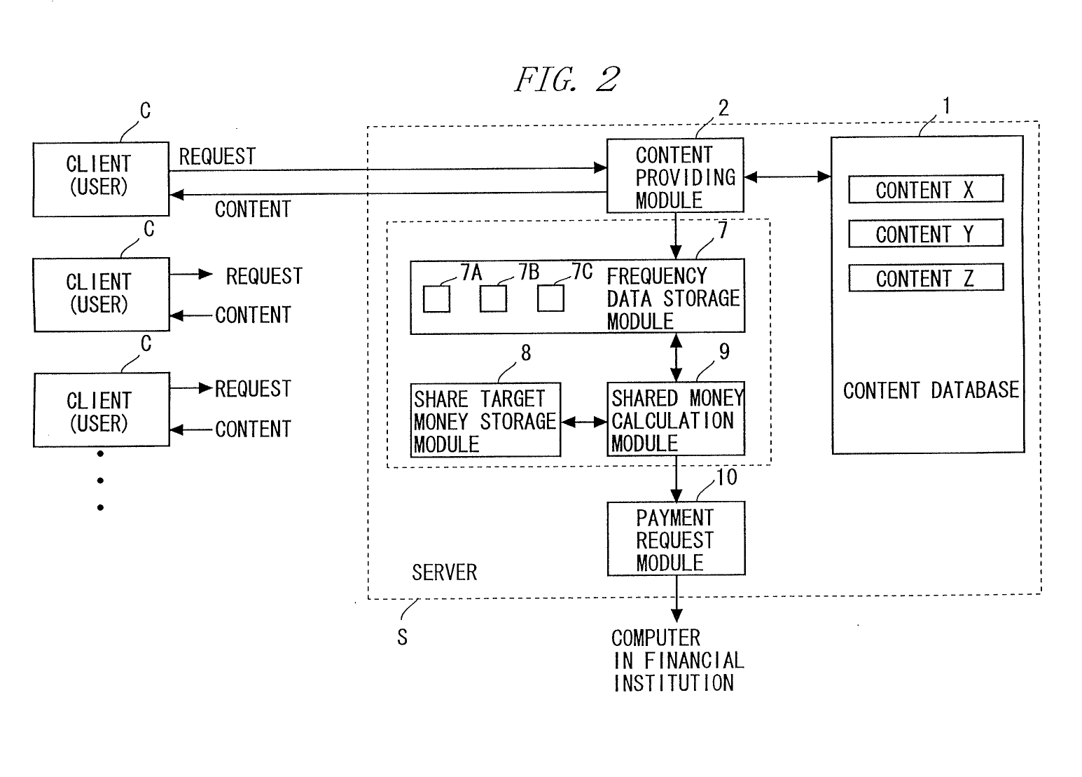

FIG. 2 is a diagram showing an example of a system for actualizing the content providing services shown in FIG. 1. The system is configured by a server S as a profits sharing device, and one or more clients C connected via a network to the server S and operated by the contractors (users) of the services.

The server S is constructed of a personal computer (PC) a workstation (WS) and a computer such as a server machine etc. on the other hand, the client C is constructed by use of a computer functioning as a network terminal such as a PC, a WS, a mobile computer, PDA (Personal Digital Assistants), mobile telephone terminals (including a PHS). The server S and the client C may be constructed of not the general-purposed computers but special devices.

The network may involve the use of the Internet, leased lines, telephone networks etc. All the routes connecting the clients C to the server in the network maybe configured by wires, and the whole or a part of the routes may also be configured wirelessly.

The server S is managed by the agent and provides each client with the content providing services. Therefore, the server S includes a database 1 stored with the plurality of contents provided from the plurality of content providers, and a content providing module 2 for providing the client with a content corresponding to a request given from each client.

A content X is a content provided from a content provider A, a content Y is a content provided from a content provider B, and a content Z is a content provided from a content provider C.

Note that the database 1 is structured by use of a recording medium provided in the computer functioning as the server S. The content providing module 2 is defined as a function actualized when a CPU of the computer executes the program.

Each user, when requesting the server S to provide contents, operates the client C and sends the request for providing the content to the server S. The content providing module 2 of the server S, when receiving the request from the client C, transfers to the client C pieces of data on a screen (content providing screen) 3 for providing the content.

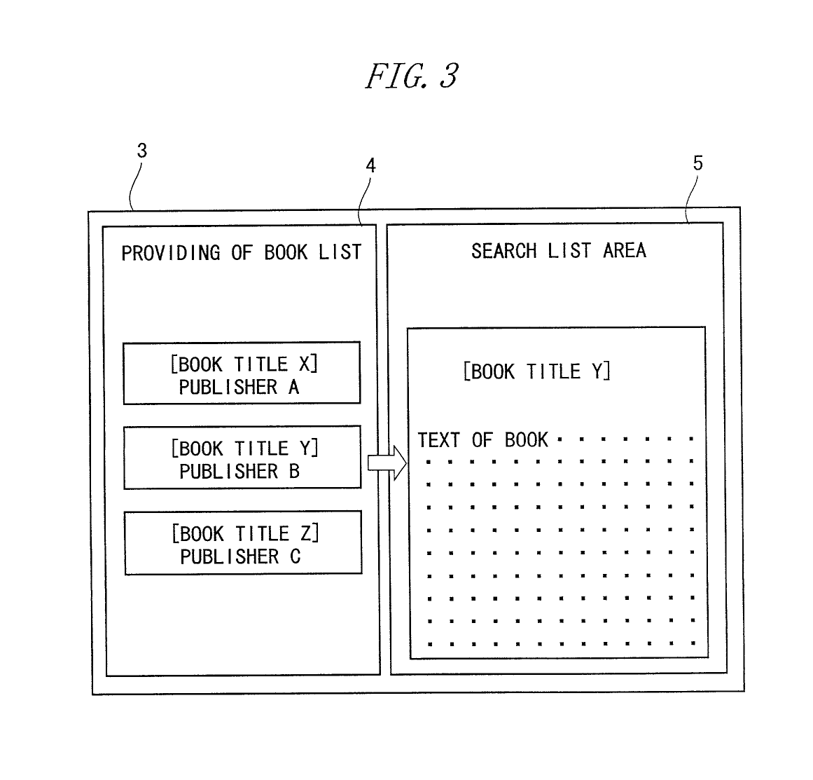

The client C displays on an unillustrated display device (display) the screen 3 based on the screen data received from the server S. FIG. 3 is a diagram showing an example of the screen 3. FIG. 3 shows an example where the respective contents X, Y and Z shown in FIG. 1 are categorized as books provided individually from the content providers (publishers) A, B and C.

The screen 3 contains a display are for displaying a list of the contents and a display area 5 for displaying the contents. The display area 4 displays the list of the plurality of providing target contents (the contents, X, Y, Z). In the example in FIG. 3, the display area 4 displays for every content titles of the books as the contents in the form of the list.

Each title displayed in the display area 4 functions as a button for the user to select a desired content, and the user operates the client C ad inputs a result of selecting the desired content (book) picked up from the list. For example, the user clicks the title displayed and is thereby capable of inputting the selected result.

When the selected result is inputted, the client C sends a request for providing the content selected. The content providing module 2 of the server S receives the request for providing the content from the client C, then fetches the content corresponding to this request out of the database 1, and transfers the content to the client C.

The client C displays the transferred content in the display area 5 on the screen 3. In the example illustrated in FIG. 2, the display area 5 displays a text of the book (the content Y) as the content selected. The user is able to browse the content (the book) displayed in the display area 5.

According to the content providing service discussed above, the content providing module 2 provides the screen 3, and the user is able to access the plurality of contents X, Y, Z through one single accessing location (the screen 3). The user is not therefore required to access an individual location per content.

Further, the user can receive the desired content by a common event (that is a click on the title of the desired content) using the screen 3. Thus, the screen 3 functions as a user interface common to the plurality of content, and the user is able to access the respective contents X, Y, Z on the same platform.

The server S shares profits acquired by the content providing services described above to the providers (the publishers) A, B, C of the plurality of contents, and, for this purpose, takes the following architecture. To be specific, the server S includes a storage module 7 for storing data about a frequency (a frequency of usage) at which each content is provided, a storage module 8 stored with the data about the amount of share target money, and a calculation module 9 for calculating shared money for each content by use of the data stored in the storage modules 7, 8.

Note that each of the storage modules 7, 8 is structured by use of a recording medium provided in the computer functioning as the server S. The calculation module 9 may be defined as a function actualized when the CPU of the computer executes the program.

The storage module 7 contains a plurality of counters prepared per content. In the example shown in FIG. 2, the storage module 7 contains counters 7A, 7B, 7C corresponding to the contents X, Y, Z.

The content providing module 2, each time any one of the plurality of contents, i.e., the contents X, Y, Z is provided to the client C, increases by one a value of the counter corresponding to the providing target content.

A counter value of each of the counters 7A, 7B and 7C is reset at a start of a predetermined period. With this contrivance, each of the counters 7A, 7B and 7C stores a content provision count (a usage (browsing) count by the user) of each content for the predetermined period (e.g., a month) as a piece of data about a providing frequency. Note that the storage module 7 may be structured to store the content provision count for the predetermined period.

The storage module 8 retains the data of the share target money. As for the share target money, for instance, the service provider may store the storage module 8 with the share target money, and the calculation module 9 may calculate the amount of share target money by use of the total sum (profits) of the service fees and the operating cost for the content providing service, and may store the calculated amount of share target money-in the storage module 8.

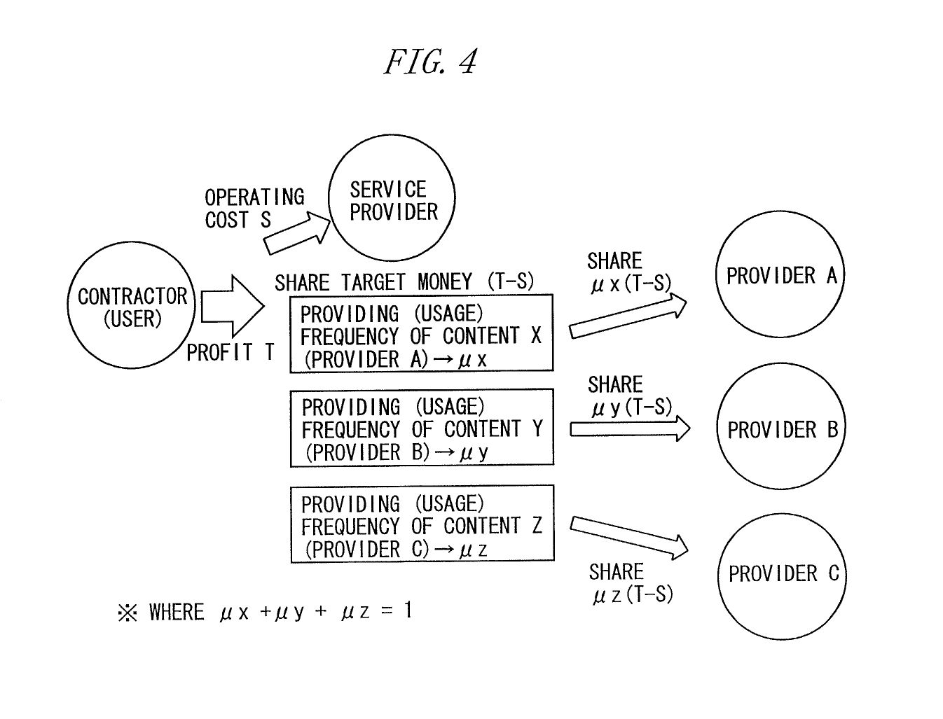

The calculation module 9 calculates the shared money for each of the contents X, Y, Z. FIG. 4 is an explanatory diagram showing processes by the calculation module 9. The calculation module 9 reads the share target money (T-S) for the predetermined period that is stored in the storage module 9. The share target money (T-S) is obtained by subtracting an operating cost S from a total sum (profits) T of the service fees.

Next, the calculation module 9 obtains a frequency (a frequency of usage) of providing each of the contents X, Y, Z for the predetermined period. More specifically, the calculation module 9 reads the content providing count (the usage count) of each of the contents X, Y, Z for the predetermined period. Next, the calculation module 9 obtains a content providing frequency (usage frequency) μ of each of the contents X, Y, Z by dividing the content providing count of each of the contents X, Y, Z by a sum of these content providing counts.

Namely, the calculation module 9 performs the following calculations.

Content X Providing Frequencyμx=Cx/Cx+Cy+Cz

Content Y Providing Frequencyμy=Cy/Cx+Cy+Cz

Content Z Providing Frequencyμz=Cz/Cx+Cy+Cz

where “Cx” is a counter value (a content X providing count) of the counter 7A, “Cy” is a counter value (a content Y providing count) of the counter 7B, and “Cz” is a counter value (a content Z providing count) of the counter 7C.

Then, the calculation module 9 multiplies the obtained frequencies μx, μy, μz by the amount of share target money (T-S), thereby obtaining amounts of shared money μx(T-S) μy(T-S), μz(T-S) corresponding to the respective contents.

The amounts of shared money μx (T-S), μy (T-S), μz (T-S) obtained by the calculation module 9 are paid to the respective content providers A, B, C. Therefore, the server S includes a payment request module 10. The payment request module 10 may be defined as a function actualized when the CPU of the computer functioning as the server S executes the program.

The payment request module 10, when receiving the amounts of shared money μx(T-S), μy(T-S), μz(T-S) from the calculation module 9, accesses a computer in an unillustrated financial institution, then requests the computer to transfer the amounts of shared money μx(T-S), μy(T-S), μz(T-S) as shares respectively into bank accounts of the content providers A, B, C by paying the amounts of shared money (T-S) from the bank account of the service provider. With this arrangement, the content providers A, B, C are able to receive the shares for providing the contents.

According to the first embodiment, each content provider is able to obtain the share corresponding to the content providing frequency of the content provided by the provider himself or herself from within the share target money. That is, each provider is allowed to gain a larger amount of share as the content providing frequency becomes higher.

Hence, even if scheming to increase the number of users and adopting a contract form of establishing a package contract with respect to providing the plurality of contents between the user and the service provider (the agent), it is possible to retrain the content providers from complaining of the shares.

Accordingly, it is feasible to inspire the content providers who solely provide the contents to participate in the present content providing services. This makes it possible to increase the number of categories of the contents provided by the content providing services, and to further expand the users.

Note that the storage modules 7, 8 and the calculation module 9 (which are the components surrounded by a broke line within the server S) are the minimum architecture required in the profits sharing system of the present invention, and may be actualized by a computer separate from the server S.

[Second Embodiment]

Next, a second embodiment of the present invention will be explained. The second embodiment has common points to the first embodiment, of which the repetitive explanations are omitted, and the discussion will be focused on different points.

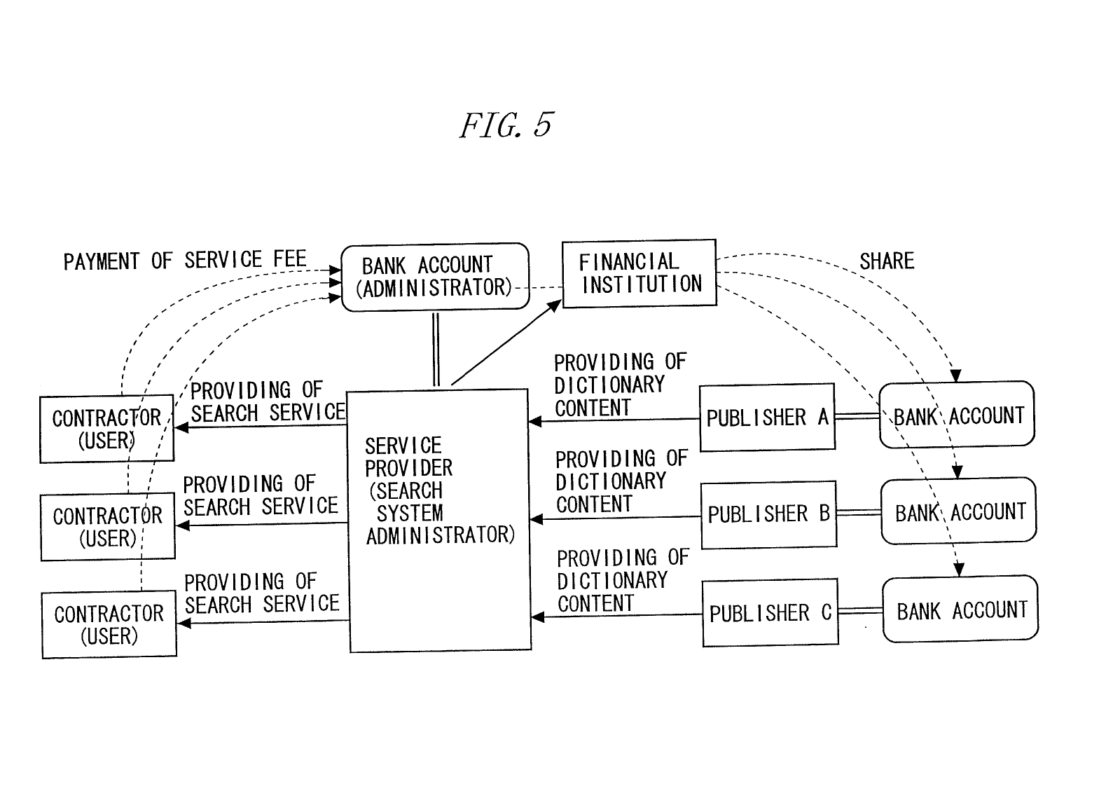

FIG. 5 is an explanatory diagram showing a content providing service (which is a dictionary search service corresponding to the [agency service] according to the present invention) in the second embodiment. Referring to FIG. 5, the service provider (the agent) retains a plurality of dictionary contents provided from the publishers A, B, C as a plurality of content providers.

The service provider manages a search system inclusive of providing the plurality of dictionary contents (which corresponds to the [service] according to the present invention) and establishes a contract for the search service using this search system with one or more users. The service provider provides the user with the search service inclusive of providing one or more dictionary contents in response to user's request.

Each user (a contractor) pays a service fee (by transferring the service fee based on the contract for every predetermined period (for instance, monthly) into a bank account of the service provider.

The service provider calculates per predetermined period a share target amount of money as an amount of money that should be shared to each of the publishers A, B, C from a total sum of service fees (profits) within that predetermined period. Based on the share target money calculated, an amount of shared money for each dictionary content is calculated in accordance with a frequency of providing the dictionary content (a frequency of using the dictionary content).

Thereafter, the service provider asks the financial institution to pay the share target money from a service provider's own bank account and to transfer the shared money to each of the publishers A, B, C. Each of the publishers A, B, C receives the shared money as a share for providing the dictionary content.

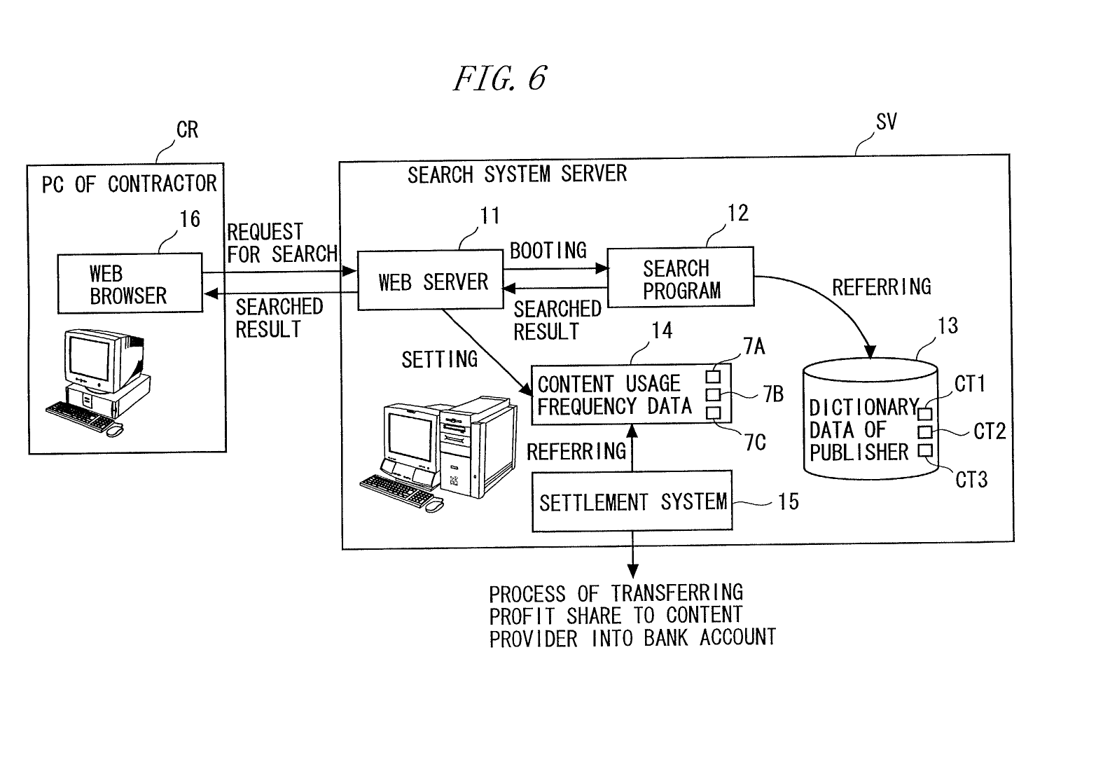

FIG. 6 is a diagram showing an example of a system for actualizing the dictionary content search service shown in FIG. 5. The system is configured by a server (search system server) SV as a profits sharing device, and one or more clients CR connected via the Internet to the server SV and operated by the contractors (users) of the service.

The server SV retains the plurality of dictionary contents and provides the contractors (users) of this search service with a WEB site for providing the dictionary search service using the plurality of dictionary contents.

The server SV therefore includes a WEB server 11, a search program 12, a database 13, a storage module 14 stored with data about a usage frequency of each content, and a settlement system 15. The database 13 is stored with dictionary contents CT1, CT2, CT3 provided from the publishers A, B, C and with files (HTML files, static image files, dynamic image files, etc) about WEB pages.

A combined function of the WEB server 11 and the search program 12 corresponds to the content providing module 2 (FIG. 2) in the first embodiment, and the database 13 corresponds to the database 1 in the first embodiment. The storage module 14 corresponds to the storage modules 7, 8 in the first embodiment, and a function of the settlement system 15 corresponds to the calculation module 9 and the payment request module 10 in the first embodiment.

The WEB site provided to the users by the server SV is operated by the search service provider. The service provider (the agent) may be a third institution separate from the content provider and may also be any one of the content providers.

A client C1 is constructed by use of, e.g., a PC and includes a WEB browser 16 that receives a WEB page containing a desired content from a server S1 and displays this WEB page on a display. The user (the contractor) is able to browse the WEB page displayed by the WEB browser 16.

<Operational Examples>

The user, when making use of the search service described above, sets a search option and makes requests for a list of searched results and for the searched result as well. The followings are explanations of these operational examples.

(Setting of Search Option)

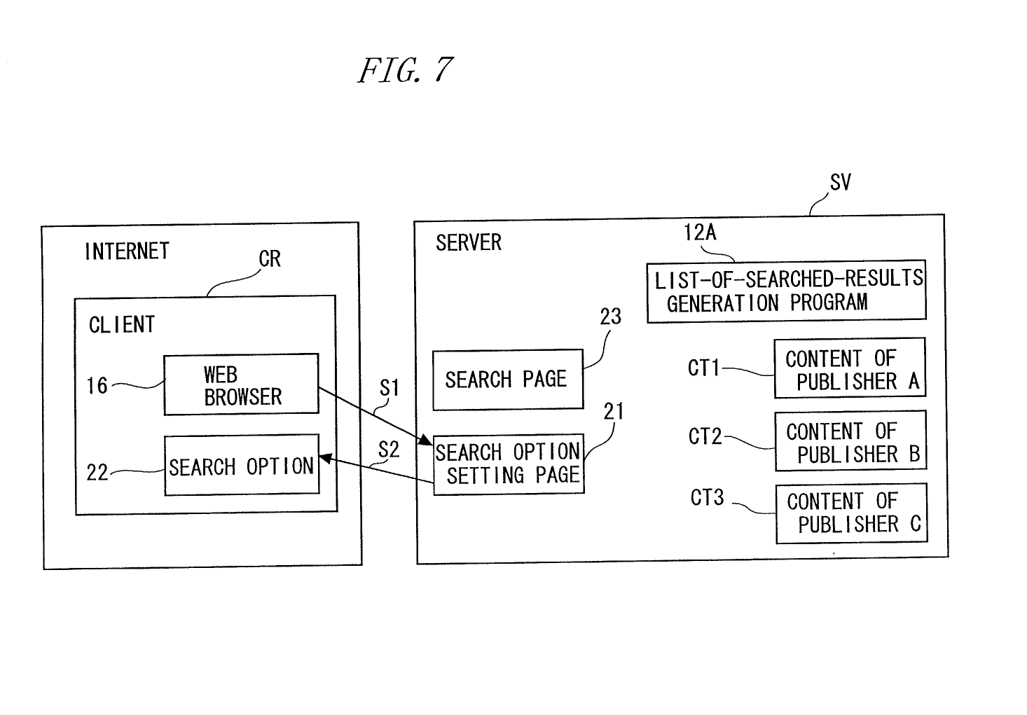

The search system prepares search options for simplifying a search operation by the user. The user is able to, when having the search service, set an option desired by the user in the search system. FIG. 7 is an explanatory diagram showing an operational example of how the search option is set.

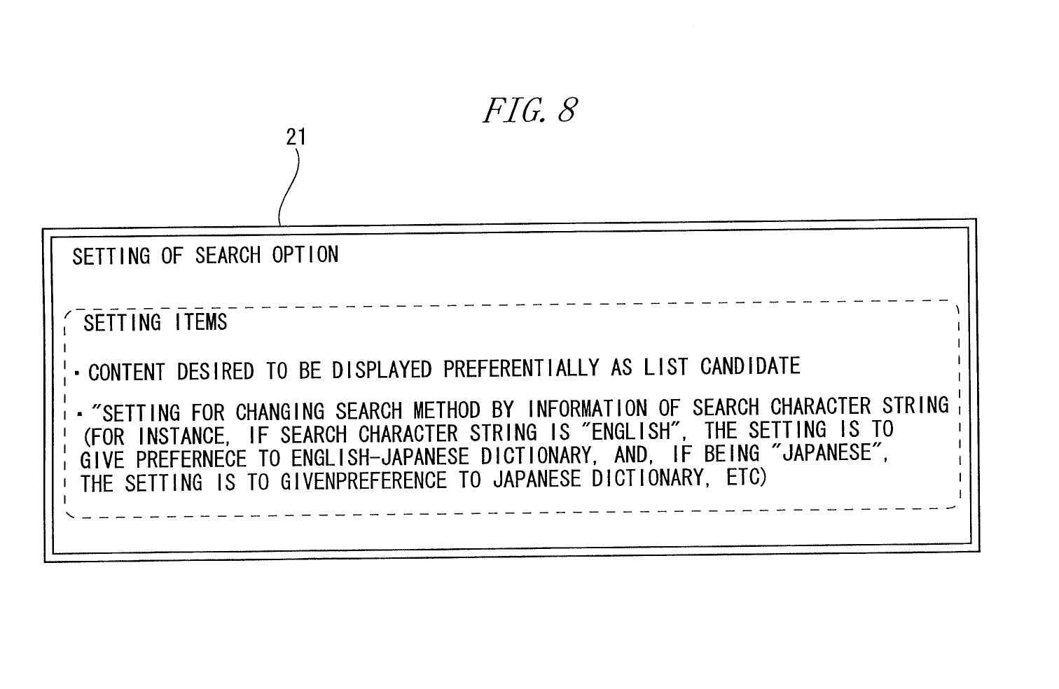

Referring to FIG. 7, the user of the client CR connected to the Internet operates the WEB browser 16, and inputs to the WEB browser 16 a request command for a search option setting page (a page 21: see FIG. 8) as a WEB page for setting the search option. Then, the WEB browser 16 obtains the page 21 (step S1).

Namely, the WEB browser 16 transmits the request for the page 21 to the server SV. The when the server SV receives the request for the page 21, the WEB server 11 boots the search program 12. The search program 12 takes a file (HTML file etc) about the page 21 out of the database 13 and sends the file to the WEB server 11. The WEB server 11 transfers the received file to the WEB browser 16. The WEB browser 16, based on the received file, displays the page 21 on the unillustrated display.

FIG. 8 is a diagram showing an example of displaying the page 21. The page 21 has an input box containing a plurality of search option setting items. The setting items are, for example, “a dictionary content desired to be preferentially displayed as a list candidate” and “setting for changing the search method by information of a search character string (for instance, if the search character string is “English”, the setting is to give a preference to English-Japanese dictionary, and, if being “Japanese”, the setting is to give a preference to Japanese dictionary, and so on).

The user browses the page 21 and inputs the set item to the client CR. The WEB browser 16 transfers the inputted set item to the server SV. The server SV creates an HTTP cookie(a technology used for the WWW server to store information in the browser and take the information therefrom by use of CGI script) (a character string issued by and stored in the WWW server as a unique piece of information using CGI (Common Gateway Interface) scrip, and the browser gets the cookie contained in every request onward to the server) containing the set item. The created HTTP cookie (search option 22) is transferred to the client CR and stored on a recording medium of the client CR (step S2).

Note that the page 21 corresponds to a setting screen according to the present invention. With the setting of the search option, the user is capable of setting a priority of the plurality of dictionary contents CT1, CT2, CT3 through the page 21 serving as the setting screen. The thus enhanced user-friendly interface is attained.

(Request for List of Searched Results)

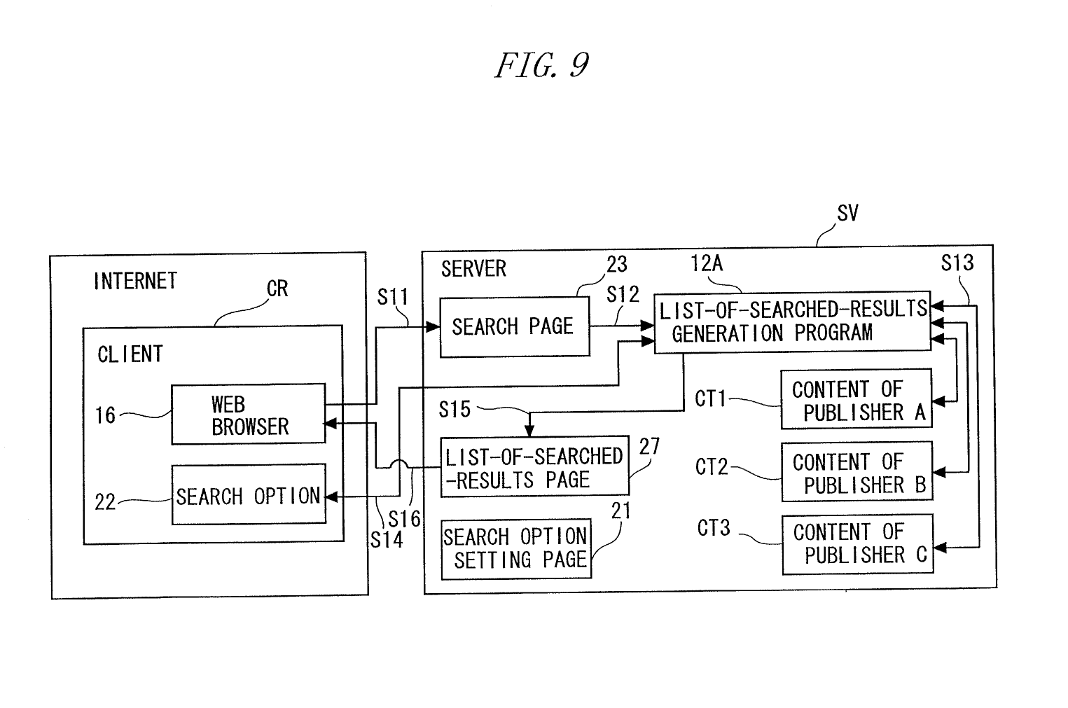

The user, with a certain search key used, when receiving the search service, makes a request for a list of searched results. FIG. 9 is an explanatory diagram showing an operational example when making the request for the list of searched results.

The user, when making the request for the list of searched results, boots the WEB browser 16 of the client CR, and inputs a command for making the request for the list of searched results. Then, the WEB browser 16 obtains a search page 23 as a WEB page for using the search service from the server SV (step S11).

That is, the WEB browser 16 transmits the request for the search page 23 to the server SV. When the server SV receives the request for the page 23, the WEB server 11 boots the search program 12. The search program 12 takes a file (an HTML file etc) about the search page 23 out of the database 13, and sends the file to the WEB server 11. The WEB server 11 transfers the received file to the WEB browser 16. The WEB browser 16, based on the received file, displays the search page 23 on the unillustrated display.

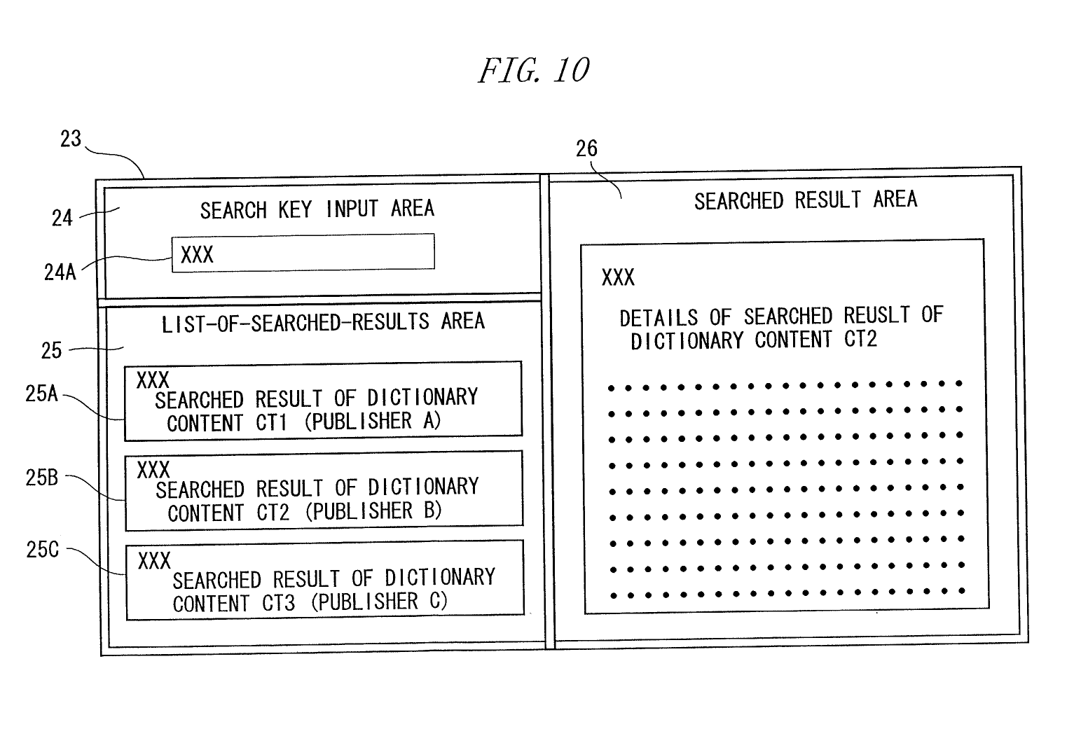

FIG. 10 is a diagram showing an example of displaying the search page 23. The search page 23 has an area (search key input area) 24 for inputting a search character string as a search key, an area (list-of-searched-results area) 25 for displaying the list of searched results, and an area (searched result area) 26 for displaying the searched result. At this stage, however, nothing is displayed in the respective areas 25, 26.

The user inputs a search character string for searching in a search character string input box 24A provided in the area 24. The search character string is thus specified. The WEB browser 16 transmits the specified search character string to the server SV.

The search character string transmitted is received by the WEB server 11 of the server SV. Then, the WEB server 11 boots a list-of-searched-results generation program 12A included in the search program 12 (FIG. 6) (step S12).

The list-of-searched-results generation program 12A searches, with the search character string used as a search key, the dictionary content CT1 of the publisher A, the dictionary content CT2 of the publisher B and the dictionary content CT3 of the publisher C which are stored in the database 13, and obtains an index (title; header) of information as a searched result that corresponds to the search character string contained in the dictionary contents CT1, CT2, CT3 (step S13).

Next, the list-of-searched-results generation program 12A obtains the search option 22 stored in the client CR (step S14). Then, the list-of-searched-results generation program 12A, based on the searched result obtained and the set item contained in the search option 22, creates data of a list-of-searched-results page 27 (step S15). The WEB server 11 transfers the data of the list-of-searched-results page 27 to the client C (step S16).

The WEB browser 16 displays list-of-searched-results page 27 in the area 25 on the basis of the received data. Searched result boxes 25A, 25B, 25C of the dictionary contents CT1, CT2, CT3 are displayed as a list of the searched results in the area 25. An index (title) of a single piece or plural pieces of information corresponding to the search character string searched from the corresponding dictionary content is displayed in each of the searched result boxes 25A, 25B, 25C. If there is no corresponding information, however, this purport is displayed. Further, a fragment of the information as well as the title may be displayed in order for the user to easily select the desired information.

Each of the searched result boxes 25A, 25B, 25C functions as a button for jumping (linking) to a corresponding searched result page 29. The user browses the results in the searched result boxes 25A, 25B, 25C displayed in the area 25, selects a dictionary content for use among the dictionary contents CT1, CT2, CT3, and specifies the selected dictionary content by clicking it with a mouse etc. Then, the WEB browser 16 requests the server SV for the searched result.

(Request for Searched Result)

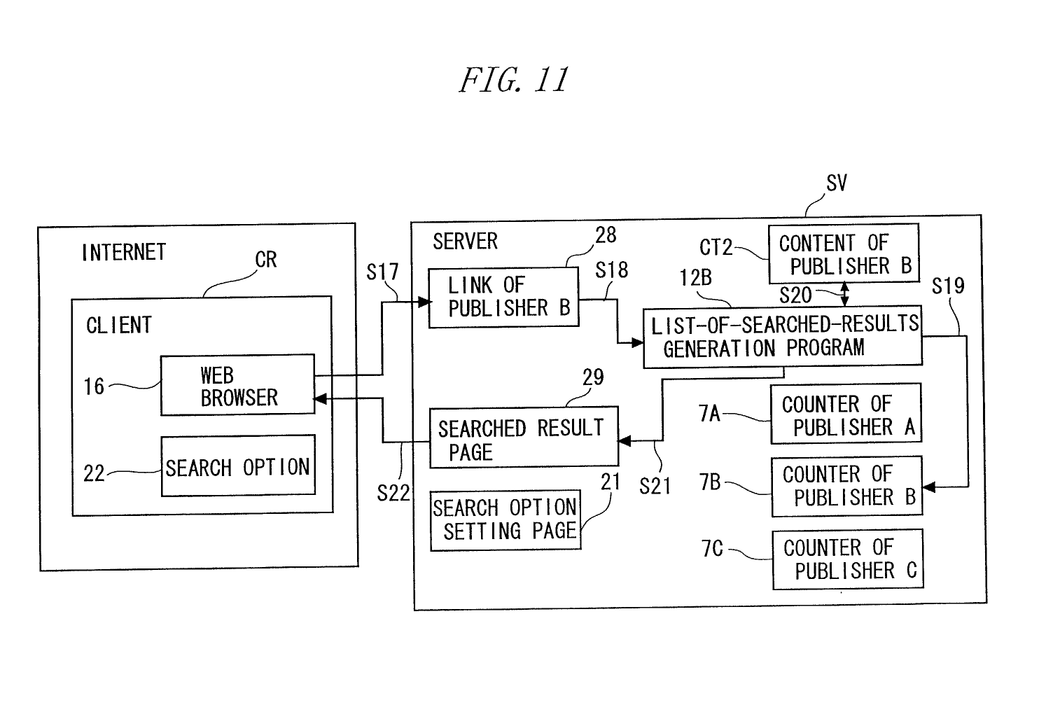

FIG. 11 is a diagram showing an operational example of a request for the searched result. Referring to FIG. 11, the WEB browser 16 transmits, as shown in FIG. 11, the request for the searched result in order to make a request for providing the specified dictionary content (step S17). Herein, it is assumed by way of an example that the dictionary content CT2 of the publisher B is specified. Note that the dictionary content CT1 of the publisher A and the dictionary content CT3 of the publisher C are not shown in FIG. 11.

The WEB server 11 of the server SV, upon receiving the request described above, boots a searched result generation program 12B included in the search program 12 in accordance with a link 28 to the dictionary content CT2 set in the searched result box 25B selected (step S18). The searched result generation program 12B increases a value of the counter 7B corresponding to the dictionary content CT2 by one (step S19).

Next, the searched result generation program 12B searches the dictionary content CT2 and reads details of the information corresponding to the index contained in the searched result box 25B as a content that should be provided to the user (step S20) Subsequently, the searched result generation program 12B generates data of the searched result page 29 by use of the details of the readout information (step S21). The WEB server 11 transfers the generated data to the client CR (step S22). The WEB browser 16, based on the transferred data, displays the searched result page 29 in the area 26 (FIG. 10) of the search page 23.

As shown in FIG. 10, the details of the information read from the dictionary content CT2 selected by the user are displayed as the searched result page 29 in the area 26. The user is able to browse the details of the information displayed. Thus, the search page 23 functions as the content providing screen 3 in the first embodiment, and the desired content is provided to the user through the search page 23.

Note that if the list of searched results is displayed in the area 25 on the search page 23, the user is, after selecting a certain dictionary content, also able to select other dictionary content by sue of the list displayed in the area 25. Namely, the user can access all the dictionary contents given in the list of searched results through the search page.

Then, if a result shown in, e.g., the searched result box 25A displayed in the area 25 is selected as other dictionary content, details of a corresponding piece of information in the dictionary content CT1 are displayed in the area 26, and a value of the counter 7A is increased by one. On the other hand, if the searched result box 25C displayed in the area 25 is selected, details of a corresponding piece of information in the dictionary content CT3 are displayed in the area 26, and a value of the counter 7C is increased by one.

(Shares of Profits)

The user of the search service monthly pays a fixed amount of service fee to the content provider. The content provider shares a share target money in a total sum of the service fees with respect to each of the dictionary contents CT1, CT2, CT3, and pays the shared money to each of the publishers A, B, C.

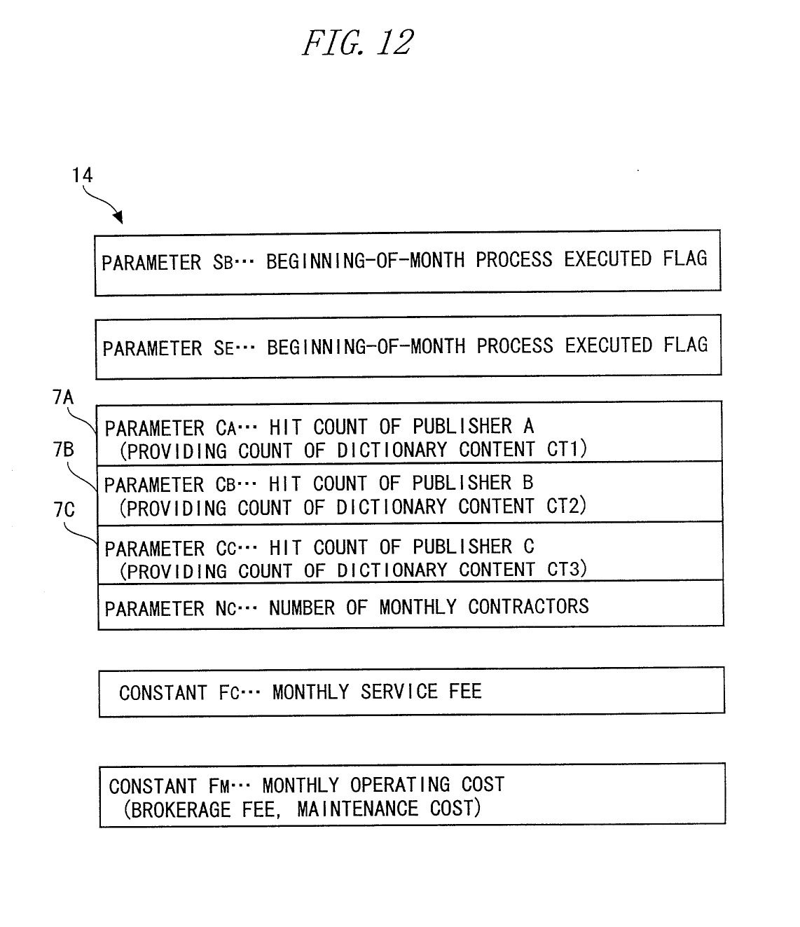

Therefore, the storage module 14 shown in FIG. 6 has a data structure shown in FIG. 12. To be specific, the storage module 14 is stored with a parameter S_{B} and a parameter S_{E}. The parameter S_{B} may be defined as a flag for showing that a beginning-of-month process which will be explained later on has already been executed, and the parameter S_{E} may be defined as a processing flag for a close-of-month process that will hereinafter be explained.

Further, the storage module 14 is stored with a parameter C_{A}, a parameter C_{B}, a parameter C_{C}, a parameter N_{C}. The parameter C_{A} is a hit count (providing count) of the dictionary content CT1 of the publisher A, and corresponds to the counter value of the counter 7A. The parameter C_{B} is a hit count (providing count) of the dictionary content CT2 of the publisher B, and corresponds to the counter value of the counter 7B. The parameter C_{C} is a hit count (providing count) of the dictionary content CT3 of the publisher C, and corresponds to the counter value of the counter 7C. The parameter N_{C} is the number of monthly users (contractors).

Moreover, the storage module 14 is stored with a constant F_{C} and a constant F_{M}. The constant F_{C} is a monthly service fee for the search service, and the constant F_{C} is the monthly operating cost (including a brokerage fee and a maintenance cost) for the search service.

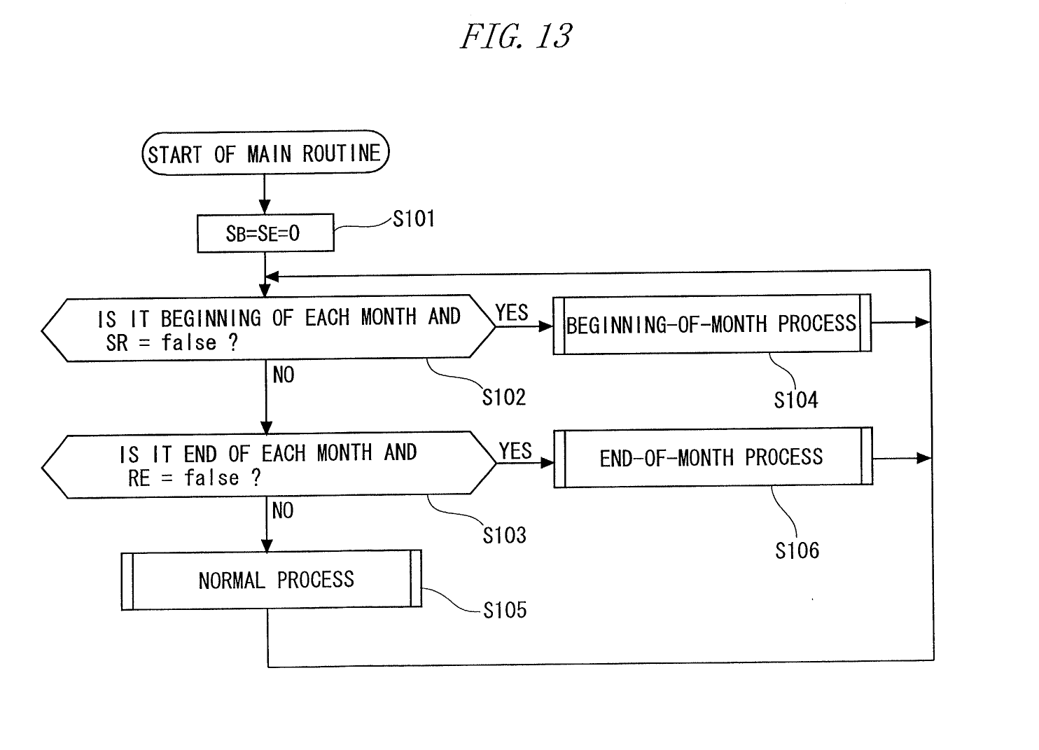

The settlement system shown in FIG. 6 executes a process of sharing the profits by use of the data stored in the storage module 14. FIG. 13 is a flowchart showing a main routine of the profit sharing process. Referring to FIG. 13, the settlement system 15, when starting the process, at first sets each of the parameters S_{B}, S_{E} to zero (which is reset to “false”) (step S101).

Next, the settlement system 15 judges whether the present date is a beginning date of a previously defined month or not and the parameter S_{B} (the beginning-of-month process executed flag) is “false” or not. If this condition is met (S102; YES), the settlement system 15, after executing the beginning-of-month process (step S104), returns the processing to step S102. Whereas if the above condition is not satisfied (S102; NO), the settlement system 15 advances the processing to S103.

In step S103, the settlement system 15 judges whether or not the present date is an ending date (a closing date) of the previously defined month or not and the parameter S_{E} (the close-of-month process (the end-of-month process)finishing flag) is “false” or not. If this condition is not met (S103; NO), the WEB server 11, after executing a normal process (step S105), returns the processing to step S102. Whereas if the above condition is satisfied (S103; YES), the settlement system 15, after executing the end-of-month process (step S106), loops the processing back to step S102.

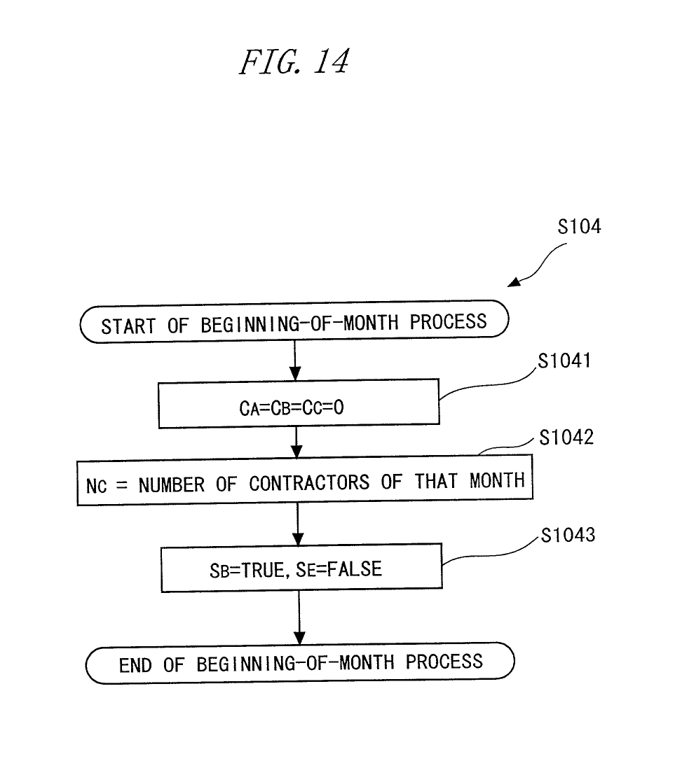

FIG. 14 is a flowchart showing the beginning-of-month process (step S104). The settlement system 15, when starting the beginning-of-month process, sets each of the parameters, C_{A}, C_{B}, C_{C} to zero (which is reset to “false”) (step S1041).

Next, the settlement system 15 sets the parameter N_{C} to the number of contractors (users) of that month (step S1042). The number of contractors is previously registered in the server SV by the service provider.

Subsequently, the settlement system 15 sets a value of the parameter S_{B} to “true”, and a value of the parameter S_{E} to “false” (step S1043). When finishing the process in step S1043, the beginning-of-month process is ended, and the processing loops back to step S102 in the main routine (FIG. 13).

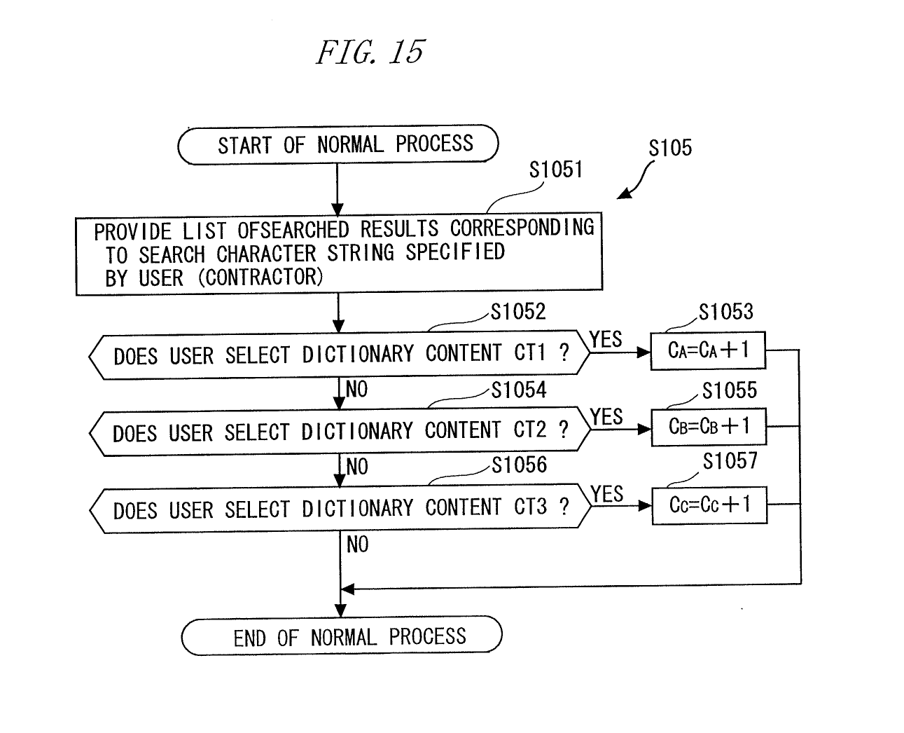

FIG. 15 is a flowchart showing the normal process (step S105). This normal process is described so as to be executed at all times when the condition in step S103 is satisfied. In fact, however, the normal process is executed when the condition in step S103 is met and further the server SV receives the request for the list of searched results and the request for the searched result.

The WEB server 11, when starting the normal process, provides the client CR (the WEB browser 16) with the list of searched results corresponding to the search character string specified by the user (contractor) (step S1051).

Next, the WEB server 11 judges whether or not the user selects the dictionary content CT1 from the list of searched results (step S1052). If the user selects the dictionary content CT1 (S1502; YES), the WEB server 11 increases the counter value (the parameter C_{A}) of the counter 7A by one (step S1053).

In this processing, if the user selects the dictionary content CT2 (S1054; YES),the WEB server 11 increases the counter value (the parameter C_{B}) of the counter 7B by one (step S1055).

In this processing, if the user selects the dictionary content CT3 (S1056; YES), the WEB server 11 increases the counter value (the parameter C_{C}) of the counter 7C by one (step S1057).

Thus, in the normal process, the WEB server 11, each time any one of the dictionary contents CT1, CT2, CT3 is selected from the list of searched results, increases the counter value (the parameter C) of the corresponding counter by one.

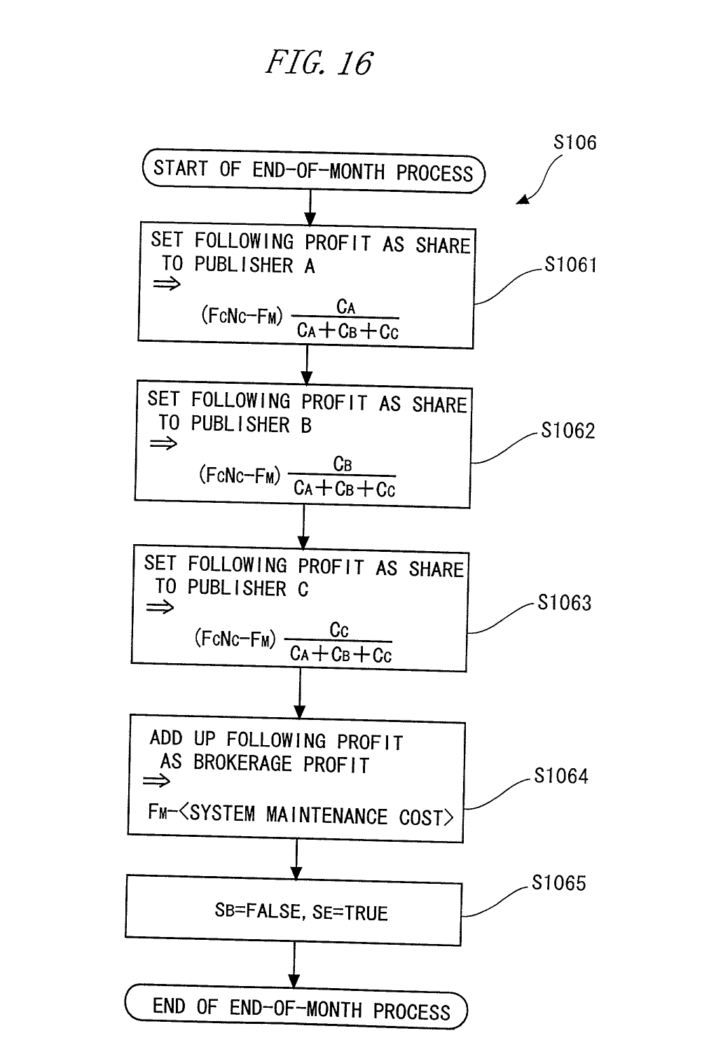

FIG. 16 is a flowchart showing the end-of-month process. The settlement system 15, when starting the end-of-month process, calculates the shared money for the dictionary content CT1 in the following calculation formula (step S1061).

Shared Money for Dictionary Content CT1=(F_{C}N_{C}−F_{M})C_{A}/C_{A}+C_{B}+C_{C}

where “(F_{C}N_{C}−F_{M})” is the share target amount of money and corresponds to “(T−S)” in the first embodiment, and “C_{A}/C_{A}+C_{B}+C_{C}” is the frequency (usage frequency) of providing the dictionary content CT1 and corresponds to “μ_{X}” in the first embodiment.

Next, the settlement system 15 calculates the shared money for the dictionary content CT2 in the following calculation formula (step S1062).

Shared Money for Dictionary Content CT2=(F_{C}−N_{C}−F_{M})C_{B}/C_{A}+C_{B}+C_{C}

where “C_{B}/C_{A}+C_{B}+C_{C}” is the frequency (usage frequency) of providing the dictionary content CT2 and corresponds to “μ_{Y}” in the first embodiment.

Subsequently, the settlement system 15 calculates the shared money for the dictionary content CT3 in the following calculation formula (step S1063).

Shared Money for Dictionary Content CT3=(F_{C}N_{C}−F_{M})C_{C}/C_{A}+C_{B}+C_{C}

where “C_{C}/C_{A}+C_{B}+C_{C}” is the frequency (usage frequency) of providing the dictionary content CT3 and corresponds to “μ_{Z}” in the first embodiment.

Next, the settlement system 15 adds up a calculated result given hereunder as an agency profit for the service provider to provide the user with the service (step S1064).

Agency Profit=F_{M}−<Cost for Maintaining Search System>

The maintenance cost described above is stored beforehand in the storage module 14.

Then, the settlement system 15 sets the parameter S_{B} to “false”, and the parameter S_{E} to “true”, and the end-of-month process is finished. The settlement system 15, when finishing the end-of-month process, access a computer (not shown) in the financial institution via the network. Then, the settlement system 15 requests the computer to pay each amount of shared money calculated to each of the publishers A, B, C defined as the providers of the dictionary contents CT1, CT2, CT3.

Th computer in the financial institution manages the bank accounts of the service providers and of the publishers A, B, C. The computer draws the amount of share target money (F_{C}N_{C}−F_{M}) from the bank account of the service provider, and transfers the shared money (F_{C}N_{C}−F_{M})C_{A}/C_{A}+C_{B}+C_{C} into the bank account of the publisher A, the shared money (F_{C}N_{C}−F_{M})C_{B}/C_{A}+C_{B}+C_{C} into the bank account of the publisher B, and the shared money (F_{C}N_{C}−F_{M})C_{C}/C_{A}+C_{B}+C_{C} into the bank account of the publisher C. The shared money is thus paid as a share to each of the publishers A, B, C.

<Operation of Second Embodiment>

According to the second embodiment, the user is able to use (receives the providing service) the plurality of dictionary contents CT1, CT2, CT3 through the search page 23 provided from the server SV.

Further, the user makes the requests for the list of searched results and for the searched result by use of the search page 23 and is thereby able to use the dictionary contents CT1, CT2, CT3. Namely, the user can use the dictionary contents CT1, CT2, CT3 by the same events on the search page 23.

Moreover, the user is able to use the plurality of dictionary contents CT1, CT2, CT3 through one contract. The user can therefore avoid being time-consuming as laborious as establishing a plurality of agreements for using the plurality of dictionary contents.

As described above, the more enhanced user-friendly interface than by the prior arts is attained. Therefore, it is feasible to expand the contractors (users) of the dictionary search service, and the service provider (the operator (administrator) of the search system) can increase the profits (the total sum of service fees (service usage fees)). As a result, the service provider is capable of setting the service fee low and making an attempt to further expand the users.

On the other hand, the plurality of dictionary contents are provided through the single WEB page (the search page 23) whereby the dictionary content provider can gain more opportunities for the users to make the use of the self-provided dictionary content and increase the number of users of the provider's own dictionary content.

Then, the dictionary content provider can obtain the share corresponding to the frequency(usage frequency) of providing the self-provided dictionary content, and therefore may receive the share without any complaint. Further, the share (shared money) is determined for the dictionary content, and hence the dictionary content provider is able to gain the share corresponding to each dictionary content if providing the plurality of dictionary contents.

With those advantages, it is possible to inspire other dictionary content providers to participate (to provide the dictionary contents to the service provider) in the search service (the WEB site). The service provider and the dictionary content provider can expect a further rise in the number of users with an increase in the number of dictionary contents.

Moreover, the dictionary content provider entrusts the service provider with providing the dictionary content to the user and, though an agency cost therefore occurs, has an advantage of having no necessity of managing and operating the WEB site (the server SV). On the other hand, the providers of the plurality of dictionary contents cooperate to be burdened with the operating cost for the search service and therefore have a less burden than in the case where each provider is individually burdened with the cost.

The first and second embodiments discussed in depth have exemplified the case where the respective contents are provided by the different providers, and the counters are provided corresponding to the respective contents. The counter and the method of calculating the shared money to the content provider by use of the counter are not, however, limited to those described above.

The architecture that the counters are provided corresponding to the contents as in the embodiments discussed above is not taken, but the following architecture may be adopted. That is, the counter is provider for every content provider, and, when the content is provided to the user, a value of the counter corresponding to the content provided is increased. Thereafter, an amount of shared money to the content provider is determined by using each counter value.

With this architecture adopted, the calculation process of obtaining the amount of shared money to be paid to the each content provider becomes easier in the case where the one single provider (the agent) provides the plurality of contents.

Note that if the modified example given above is adopted, it is preferable to specify the provider of the content provided to the user by utilizing a table recorded with mappings of the contents to the providers, and so on.

Further, according to the second embodiment, the dictionary content has been exemplified as the content, however, the categories of the contents such as the dynamic images, the static images and the voices provided to the users according to the present invention, are not confined to those described above. Moreover, the contents provided from the plurality of content providers are not limited to those of the same category, and the contents of categories different from each other may also be provided to the users.

The first and second embodiment discussed in depth have exemplified the method of calculating the shared money of the profits paid to the respective providers for the service of providing the contents (the information) provided by the plurality of providers.

The target of the profit sharing method according to the present invention is not, however, confined to the content and may include the service provided by the provider.

Namely, the present invention can be also applied to such a profit sharing method that the [provider] described in the first and second embodiments provides the variety of services, [the service provider (agent)] performs the agency service for presenting the service provider by the provider to the user, and the profits may be shared to the respective providers in accordance with the usage frequency of the service used by the user.

The following is an explanation of the process in this example. Note that the contracts agreed upon between the plurality of service providers and the agent and the contracts between the users and the agent, are the same as those n the embodiments discussed above, and therefore their repetitive explanations are omitted. Further, the method of calculating the amount of shared money to each provider, the method of collecting the service fees from the users and the settlement to each provider, are also the same as those described above, and therefore their repetitive explanations are omitted.

To start with, the server of the service provider (the agent) transmits to the client a list of the plurality of services provided by the plurality of service providers in response to a request of the client (the user).

The client receiving the list of services displays the list of services on the screen, and there comes to a standby status for the user to input a selected result.

When the user selects a desired service from the service list, the client transmits a piece of information specifying the selected service to the server of the service provider, and the server increases by one a value the counter corresponding to the service selected by the user.

Further, the server executes the process for providing the user with the service selected by the user. For example, the server connects the system where the service is provided by the provider to the client used by the user. For instance, the WEB site operated by the provider is connected to the client.

As discussed above, the present invention can be applied to the agency service with respect to he general [services] provided by the [providers] as well as to the agency service for brokering in providing the [contents].

Namely, the content providing service including the dictionary search service explained in the first and second embodiments, is one example of the agency service for brokering in providing the contents, and the present invention is not limited to this service.

What is claimed is:

1. A profit sharing system for an agency service, comprising:
a storage module storing amounts of share target money, which should be shared to a plurality of providers, of profits obtained by operating for a predetermined period an agency service for providing users with a plurality of services provided from a plurality of providers; and
a calculation module calculating an amount of shared money allocated to each service from within the amount of share target money stored in the storage module on the basis of a frequency of providing each service during the predetermined period.

2. A profit sharing system according to claim 1, wherein said calculation module includes:
a providing count storage module storing a providing count of each service during the predetermined period; and
a shared money calculation module calculating a frequency of providing each service by dividing a counted providing count of each service by a total sum of the service providing counts and calculating the amount of shared money allocated to each service by multiplying each of the calculated frequencies by the amount of share target money.

3. A profit sharing system according to claim 1, wherein the profits are a total of agency service usage fees during the predetermined period that are collected from the users on the basis of one single contract.

4. A profit sharing system according to claim 1, wherein the amount of share target money is an amount obtained by subtracting an operating cost for the agency service from the profits.

5. A profit sharing system according to claim 1, further comprising a request module requesting a financial institution to pay the shared money to each provider.

6. A profit sharing system according to claim 2, further comprising:
a database stored with a plurality of contents provided by the plurality of providers; and
a content providing module obtaining a content corresponding to a request of the user as the service from said database and providing the user with this content, and storing a providing count of each content in said providing count storage module.

7. A profit sharing system according to claim 6, wherein the content is a dictionary content, and
said content providing module provides the user with a list of dictionary contents corresponding to a search key received from the user, and provides the user with the dictionary content selected from this list by the user.

8. A profit sharing method for an agency service, comprising:
storing amounts of share target money, which should be shared to a plurality of providers, of profits obtained by operating for a predetermined period an agency service for providing users with a plurality of services provided from a plurality of providers; and
calculating an amount of shared money allocated to each service from within the stored amount of share target money on the basis of a frequency of providing each service during the predetermined period.

9. A profit sharing method according to claim 8, wherein said calculating the amount of shared money includes:
storing a providing count of each service during the predetermined period; and
calculating a frequency of providing each service by dividing a counted providing count of each service by a total sum of the service providing counts and calculating the amount of shared money allocated to each service by multiplying each of the calculated frequencies by the amount of share target money.

10. A profit sharing method according to claim 8, wherein the profits are a total of agency service usage fees during the predetermined period that are collected from the users on the basis of one single contract.

11. A profit sharing method according to claim 8, wherein the amount of share target money is an amount obtained by subtracting an operating cost for the agency service from the profits.

12. A profit sharing method according to claim 8, further comprising requesting a financial institution to pay the shared money to each provider.

13. A profit sharing method according to claim 2, further comprising obtaining a content corresponding to a request of the user as the service from a database stored with a plurality of contents provided by the plurality of providers, and providing the user with this content and storing a providing count of each content.

14. A profit sharing method according to claim 13, wherein the content is a dictionary content, and
said providing the user with the content includes:
providing the user with a list of dictionary contents corresponding to a search key received from the user, and providing the user with the dictionary content selected from this list by the user.

15. A storage medium readable by a computer, tangibly embodying a program of instructions executable by the computer to perform method steps, the method steps comprising:
a step of storing amounts of share target money, which should be shared to a plurality of providers, of profits obtained by operating for a predetermined period an agency service for providing users with a plurality of services provided from a plurality of providers; and
a step of calculating an amount of shared money allocated to each service from within the stored amount of share target money on the basis of a frequency of providing each service during the predetermined period.

16. A storage medium according to claim 15, wherein said step of calculating the amount of shared money includes:
a step of storing a providing count of each service during the predetermined period; and
a step of calculating a frequency of providing each service by dividing a counted providing count of each service by a total sum of the service providing counts and calculating the amount of shared money allocated to each service by multiplying each of the calculated frequencies by the amount of share target money.

17. A storage medium according to claim 15, wherein the profits are a total of agency service usage fees during the predetermined period that are collected from the users on the basis of one single contract.

18. A storage medium according to claim 15, wherein the amount of share target money is an amount obtained by subtracting an operating cost for the agency service from the profits.

19. A storage medium according to claim 15, said program further comprising a step of requesting a financial institution to pay the shared money to each provider.

20. A storage medium according to claim 16, said program further comprising a step of obtaining a content corresponding to a request of the user as the service from a database stored with a plurality of contents provided by the plurality of providers, and a step of providing the user with this content and storing a providing count of each content.

21. A storage medium according to claim 20, wherein the content is a dictionary content, and
said content providing step includes:
a step of providing the user with a list of dictionary contents corresponding to a search key received from the user, and providing the user with the dictionary content selected from this list by the user.

22. A profit sharing system according to claim 6, wherein said content providing module provides a setting screen for the user to set a priority of the plurality of dictionary contents.

23. A profit sharing method according to claim 13, wherein said content providing step includes a step of providing a setting screen for the user to set a priority of the plurality of dictionary contents.

24. A storage medium according to claim 20, wherein said content providing step includes a step of providing a setting screen for the user to set a priority of the plurality of dictionary contents.

25. A profit sharing system for an agency service, comprising:
a providing module providing an agency service for providing a user with a requested service among services provided by a plurality of providers; and
a calculation module calculating an amount of shared money, shared to each provider, of profits obtained by providing the agency service on the basis of a frequency of providing the user with the service.

26. A profit sharing method in an information processing system, for an agency service, including a storage module and a control unit, said method comprising:
making said control unit provide the agency service for providing a user with a requested service among services provided from a plurality of providers;
storing said storage module with a providing count of providing the service to the user; and
calculating an amount of shared money, shared to each provider, of profits obtained by the agency service on the basis of a providing frequency of each service that is obtained from the providing count of each service and a total sum of service providing counts.

27. A storage medium readable by a computer, tangibly embodying a program of instructions executable by the computer to perform method steps, the method steps comprising:
a step of providing the agency service for providing a user with a requested service among services provided from a plurality of providers;
a step of storing said storage module with a providing count of providing the service to the user; and
a step of calculating an amount of shared money, shared to each provider, of profits obtained by the agency service on the basis of a providing frequency of each service that is obtained from the providing count of each service and a total sum of service providing counts.
